(19) United States
(12) Patent Application Publication
(10) Pub. No.: US 2004/0192297 A1
(43) Pub. Date: Sep. 30, 2004

(54) System and method for enabling and enhancing spending limits functionality in post-paid wireless billing systems

(76) Inventors: Thomas Erskine, Marblehead, MA (US); Kenneth W. Sonberg, Andover, MA (US); Marco A. Terry, Woburn, MA (US); John R. Cooper, Rensselaerville, NY (US); John W. Hayes JR., North Reading, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/755,857

(22) Filed: Jan. 12, 2004

Related U.S. Application Data
(60) Provisional application No. 60/439,294, filed on Jan. 10, 2003.

(51) Int. Cl. H04Q 7/20

(52) U.S. Cl. 455/432.1; 455/428; 455/445

(57) ABSTRACT

A system and method for allowing wireless carriers to implement intelligent spending-limited products to their post-paid subscribers. The system and method can be deployed separate from but cooperative with legacy billing environments or integrated with a carrier's billing and customer care suite. The system reduces latency in collecting and rating event-related data for roaming and local spending limits subscribers, enables selective deployment of real-time subscriber management based upon a carrier-definable threshold matrix, provides proactive messaging premised upon various account-related metrics, and enables the acceptance and immediate crediting of subscriber payments.

### CROSS REFERENCE TO RELATED APPLICATIONS

This application claims priority of U.S. Provisional Patent Application No. 60/439,294, filed Jan. 10, 2003, entitled “Network Governor System Conceptual Design Document,” the contents of which are incorporated herein by reference.

### STATEMENT REGARDING FEDERALLY SPONSORED RESEARCH OR DEVELOPMENT

N/A

### BACKGROUND OF THE INVENTION

As wireless telephone subscription rates in the United States reach fifty percent of eligible consumers, carriers are challenged with targeting new subscriber segments to fuel the next wave of revenue growth. As a result, innovative service providers have deployed new hybrid service plans for subscribers who desire and/or who require control over their wireless usage and spending.

Hybrid offerings, such as “spending limits” plans, combine the benefits of a traditional post-paid account with a usage limitation function that prevents the subscriber from exceeding a certain level of use. A spending limits plan is similar to a traditional post-paid plan but has a credit limit associated with it. Subscribers to spending limits plans may be required to submit a deposit, and aggregate and/or billing cycle limits may be imposed.

Such plans are particularly appropriate for subscribers with sub-optimal credit ratings. While these offerings have succeeded in increasing subscriber growth, they have also increased carrier operational costs, churn, and bad debt to the extent that some carriers have questioned the profitability of these plans. In particular, smaller carriers have found that bad debt, associated especially with roaming charges, and fraud associated with existing spending limits solutions have made it difficult to justify pursuit of customers from this credit-challenged class.

Currently available spending limits plans rate Call Data Records (CDRs) and update subscriber records with varying frequency. For instance, CDRs may be forwarded to a typical billing system in batch mode such as via File Transfer Protocol (FTP). Once received, the records are typically accumulated before being rated in batch by the billing system. Finally, a typical billing system applies these rated CDRs to individual subscriber accounts for balance adjustment (for example, in connection with rendering a bill) only once per billing cycle. With a low frequency of balance adjustment, a high degree of “balance management latency” exists and, as a result, service de-provisioning is typically only possible after a substantial period of time with the consequence of a potentially high negative balance. This is particularly true for CDRs of roaming calls which may take several days to be processed through a wireless network clearinghouse and delivered to the home carrier.

Customer satisfaction with such plans has also suffered due to inadequate communication regarding account balance status, bills that significantly exceed a promised upper spending limit, and unforeseen service interruption due to a negative account status. Further, even when a subscriber has been notified of a service interruption due to, for instance, an inadequate account balance in a spending limits plan, prior art billing systems have only provided for payment crediting in relatively infrequent batch mode, thus placing a greater burden on Customer Service Representatives (CSRs) and frustrating customers who continue to have interrupted service despite having made a payment. These deficiencies have led to the increased costs, churn and bad debt alluded to above.

Some carriers have opted to offer spending limits plans which do not include roaming capability. These offerings take advantage of systems that offer a relatively low degree of balance management latency, thus allowing better control over service de-provisioning in order to limit bad debt. However, restricting such plans to local service makes these offerings much less appealing to subscribers.

The industry requires a system where, as a prerequisite, accurate account status can be known with a relatively low degree of latency and such status can be used by carriers in providing intelligent control over service usage by spending limits subscribers. Specifically, such a mechanism should introduce selective use of real-time call control resources, expedient delivery and rating of roaming call detail records without the explicit cooperation of serving wireless operators, proactive messaging, and real-time payment processing.

### BRIEF SUMMARY OF THE INVENTION

Cost savings for a carrier providing post-paid services to a credit-challenged class of subscribers are maximized not only when real-time call control resources are deployed, but when these relatively expensive resources are deployed in an intelligent, selective manner. Real-time call control, in this context, refers to pre-call authorization and processing and real-time call monitoring. The presently disclosed system and method allow carriers to implement spending-limited products, with intelligent use of real-time call control resources, for their post-paid subscribers. The system and method, referred to herein collectively as “Network Governor,” can be deployed in conjunction with legacy billing environments, with an integrated billing and customer care suite as described herein, or in a hybrid system combining both legacy information technology platforms and new, integrated billing and customer care components.

A fundamental aspect of Network Governor is the ability to intelligently utilize real-time call control resources on the basis of a configurable set of subscriber-specific and/or subscriber-generic characteristics. With real-time call control, a call is authorized prior to call completion based upon an acceptable account balance or other factors known to the system. A call is then monitored (e.g., timed) in real-time to ensure that the call does not exceed a threshold (e.g., a time limit) previously established on the basis of the respective account. If the threshold is met, the call can, at the carrier's option, be interrupted. The latter capability is particularly important in instances where the subscriber has a low balance and is at risk of exceeding their available credit.

The carrier determines on what basis a spending limits subscriber is switched from post-call supervision, or “near real-time supervision,” to pre-call processing with real-time monitoring, or “real-time call control,” and vice versa. Use of expensive real-time resources is thus limited to subscribers whose account status requires a more stringent method of measuring and accounting for events. System flexibility, including selection of pre-call authorization thresholds, message triggers, and message contents, enables carriers to take into consideration the cost of deploying real-time call control resources versus the savings those resources generate.

The system and method enable event-related data collection for spending limits subscribers, with subsequent balance management, performed with a high enough frequency and low enough latency for both home area and roaming calls, to support a fundamental aspect of the presently disclosed invention: to employ intelligent and selective use of real-time call control resources. In addition, these capabilities can cause targeted voice and/or text messages to be provided by carriers for alerting subscribers to low-balance conditions, overdue payments, and/or impending interruption of service due to account balance issues. Such messages may also alert the subscriber to an ability to make a necessary payment.

Another advantage of the presently described system and method involves acceptance of payments and real-time crediting of such payments to the respective subscriber's account with the ability to immediately adjust the treatment for the respective subscriber, if appropriate.

Regardless of the specific implementation, the Network Governor system addresses the three main business challenges of hybrid or spending limits plans: high operational costs; churn resulting from customer dissatisfaction; and bad debt. Subscriber information is maintained in real-time or near real-time and proactive notifications and bill payment reminders can be provided to subscribers at key account balance threshold levels and/or at preset times within the subscriber life cycle. Such functionality minimizes customer confusion, thereby leading to decreased need for customer care, less churn, and decreased collection costs. It also decreases the likelihood of negative balances and the provisioning of services which will not be paid for. Because the system has the ability to switch from near real-time call control mode to real-time call control mode, a subscriber whose account balance reaches a particular limit can be disallowed from further calling and can be directed to a payment gateway, such as an Interactive Voice Response (IVR) system, on-line payment portal, or Customer Support Representative (CSR). It is the intent of the presently disclosed system, however, to minimize the need for relatively expensive CSRs through proactive messaging and automated customer self-service capabilities. The payment channels are configured to enable real-time crediting of a payment against the subscriber's account.

One aspect of Network Governor, referred to as Treatment Handler, applies predetermined business rules to subscriber account characteristics to determine whether real-time call control should be invoked or if post-call supervision is adequate. The capability to assess a subscriber's account profile against thresholds and intelligently deploy real-time call control or post-call supervision is known as “Smart Supervision” and resides within the Treatment Handler. Carriers are provided with the ability to customize the threshold(s) and to configure the Treatment Handler response to threshold crossing.

Treatment Handler subscriber account analysis also determines whether a subscriber should receive a message indicative of account status, such as the need for payment. Text messages may be delivered in batch mode to all affected subscribers, via text messaging, at an appropriate time. Voice messages customized for individual subscribers can also be provided before, during and after a call to or from a subscriber.

From a subscriber's perspective, spending limits service enabled by use of Network Governor means that there will be warning messages if a deposit account nears depletion or if a scheduled payment is past due. Unforeseen interruptions in service are thus avoided while account status awareness and accuracy are increased, leading to greater customer satisfaction and reduced likelihood of non-payment for services used.

### BRIEF DESCRIPTION OF THE SEVERAL VIEWS OF THE DRAWINGS

The foregoing features of this invention as well as the invention itself may be more fully understood from the following detailed description of the drawings, of which:

FIG. 1 is a functional block diagram of a first embodiment of a system enabling and enhancing spending limits functionality in a post-paid wireless billing system according to the presently disclosed invention;

FIG. 2 is a flow chart illustrating call processing for a local subscriber who has an acceptable account status;

FIG. 3 is a flow chart illustrating call processing for a local subscriber who has a marginal account status;

FIG. 4 is a flow chart illustrating call processing for a local subscriber who has a marginal account status and who has exceeded an available amount of resources;

FIG. 5 is a flow chart illustrating call processing for a roaming subscriber who has an acceptable account status;

FIG. 6 is a flow chart illustrating call processing for a roaming subscriber who has a marginal account status;

FIG. 7 is a flow chart illustrating call processing for a roaming subscriber who has a marginal account status and who has exceeded an available amount of resources; and

FIG. 8 is a block diagram of a hardware platform capable of implementing the one or more embodiments of the presently disclosed invention.

### DETAILED DESCRIPTION OF THE INVENTION

Network Governor is an application that selectively uses pre-call authorization and processing with real-time monitoring, collectively referred to as real-time call control, to enable wireless carriers to implement spending limited products, reduce the number and magnitude of negative balances, streamline the subscriber experience, shape subscriber payment habits, and reduce bad debt.

Overall, Network Governor benefits carriers by reducing the latency in balance management, while at the same time minimizing the cost of using more expensive real-time resources. A first facet of Network Governor includes selective use of these real-time resources for performing authorization, call control, and call detail record information collection (as compared to near real-time, post-call supervision and accounting). This can be accomplished in both home and roam locations without any special or additional cooperation from the involved wireless carrier (aside from a standard roaming service agreement). A process known as Roaming Record Acceleration (RRA) can be used in managing subscriber roaming activity and for accelerating the delivery of post-call Call Detail Records (CDRs) to Balance Management and/or to a carrier's billing system. A second facet involves selective use of messaging resources for advising certain subscribers of account-related issues. A third facet involves the real-time acceptance and crediting of payments made by subscribers to the respective account.

Customers are introduced to Network Governor by their selection of a limited spending rate service plan or by a carrier's determination that the customer's usage needs to be monitored to limit exposure to uncollectable revenue. The carrier's decision may be based upon a credit-worthiness rating or similar metric. For a corporate customer, a spending limits service plan enabled by Network Governor can be used to limit unauthorized usage of corporate resources.

Enrollment in a Network Governor-enabled service plan may occur either through a carrier's legacy information technology (IT) platform or via a customer service portal associated with the Network Governor system itself. This portal may be accessed through a variety of channels, including Internet, intranet, voice line, or text messaging channel.

Network Governor functionality can be implemented in a variety of ways according to the needs and desires of a respective carrier. A description of the various functional components of Network Governor is provided in the context of one implementation which segregates Network Governor from a carrier's IT platform. Other implementations will be described subsequently.

While wireless telephone calls are described herein as the events processed by Network Governor, it is to be appreciated that wireless data usage, SMS exchanges, etc. can all be processed by Network Governor. Thus, though much of the present description refers to “calls,” the same processing can be invoked for such other types of events such as SMS text messages or data sessions. Also, various types of calls can qualify as ratable events, including normal calls, call waiting calls, and multi-party calls.

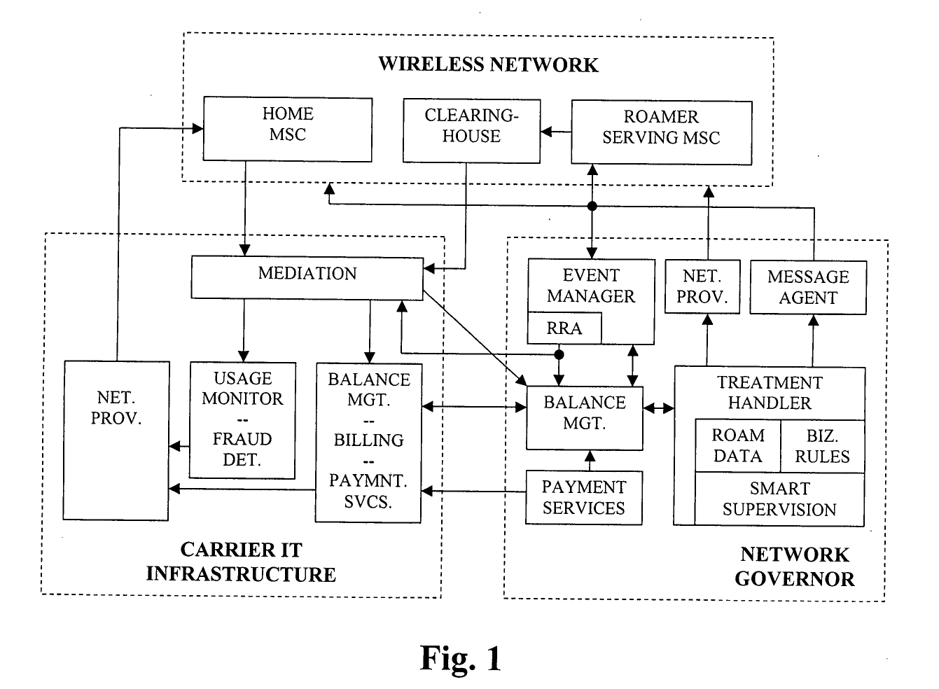

FIG. 1 illustrates an instance of Network Governor configured for use in parallel with a carrier's legacy IT infrastructure. This infrastructure is comprised of the hardware and software applications that implement and operate the Operations and Business Support Systems required to provide wireless service to subscribers. The network-based Mobile Switching Center (MSC) delivers unrated Call Detail Records (CDRs) on a periodic basis to a Mediation platform or directly to the post-paid Billing system. The Mediation platform is capable of performing data transformations and optionally multicasting records to applications such as the Usage Monitor and Fraud Detection function and to Network Governor. These records are rated and used for balance management purposes.

As the signaling interface to the wireless network, Network Governor's Event Manager enables call connection, message insertion, and call interruption. Specifically, the Event Manager is responsible for alerting the remaining portions of Network Governor that a call request for a subscriber whose account requires real-time call control has been received and to implement pre-call authorization and processing, if appropriate and if so instructed.

Each subscriber is provisioned so that the Event Manager is capable of interfacing to the wireless network to be aware of all activity involving the respective spending limits subscriber. Depending upon the environment, network interfacing can be through an ANSI-41 Telephony Interface Node (TIN), handset-based call control application, Intelligent Network (IN) triggers, among others.

The following is a partial list of various network embodiments with which Network Governor can operate:

Pre-IN (Intelligent Network) ANSI-41 with Hotline TIN (Telephony Interface Node) for roaming calls;

Pre-IN GSM (Global System for Mobile communications) with a handset-based call control application (e.g. Subscriber Identify Module (SIM) -resident application) for roaming calls;

GSM using a handset-based call control application (e.g. a SIM-resident application) for all call processing;

GSM using CAMEL (Customized Applications for Mobile networks Enhanced Logic) for home and on-net roaming and a handset-based call control application (e.g. a SIM-resident application) for off-net roaming; and

ANSI-41 using WIN (Wireless Intelligent Network) for home and on-net roaming and Hotline TIN for off-net roaming.

For pre-call authorization, information including date and time, call service area, and dialed number (for subscriber-originated calls) is sent to Balance Management which maintains a database of subscriber-related data. A Treatment Handler function then operates on the basis of a subscriber data. Balance Management and Treatment Handler will be discussed in detail subsequently. Pre-call processing by the Event Manager includes storing a maximum call threshold determined by and received from Balance Management in preparation for call timing.

After the call is terminated, data characterizing the call is collected by the Event Manager and assembled in what is referred to herein as a call artifact or unrated Call Detail Record (CDR). This data preferably includes complete and accurate information characterizing the event, and includes at least: called party identification; calling party identification; call direction; start and end times; duration; call disposition; and the service area. An identification of roaming mobile origination and/or roaming mobile termination is determined from this information. Call disposition includes: normal termination; dropped call; busy; ring/no answer; and blocked calls, among others. This data is then provided to Balance Management for immediate rating and balance adjustment.

The same data is also collected by the Event Manager for post-call supervised calls. Post-call processing and supervision, as will be discussed below, includes an analysis of subscriber-specific account data after a just-terminated call has been accounted for in order to assess whether real-time call control is required for subsequent events chargeable to the subscriber or whether post-call supervision remains appropriate.

The Network Provisioning function of Network Governor is responsible for sending messages to various network elements such as, depending upon the network type, Home Location Registers (HLRs) or call management applications resident in a Subscriber Identity Module (SIM) or other call managing resource located within subscriber handsets. The Network Provisioning function is responsible for establishing and/or modifying the mode and type of service to be provided to one or more subscribers, depending upon account type and account status, as instructed by the Treatment Handler.

For instance, if it is detected that a spending limits subscriber has exceeded a spending threshold, Network Governor can cause Network Provisioning to change the Class of Service for the subscriber (in an ANSI-41 network) or call processing routine within a respective SIM (for example, in a handset-based solution in a GSM network) such that real-time call control is invoked when subsequent events are initiated by this subscriber. Ultimately, it is the configurable business rules associated a Smart Supervision function of Treatment Handler which determine when and how the service is to be changed and it is Network Provisioning which implements the change by modifying the appropriate subscriber service profile.

Referring again to the Network Governor implementation of FIG. 1, post-call rating of CDRs assembled by and received from the Event Manager is performed by the Balance Management functional block. Balance Management also encompasses a functional subsystem which is responsible for accessing and updating the subscriber database information. Balance Management is capable of immediately rating calls, wireless data usage, and other network events such as SMS. It is preferably implemented on a scalable and fully redundant hardware platform. Depending upon the implementation, Balance Management for spending limits subscribers may be performed by discrete equipment as compared to that for non-spending limits subscribers. The exchange of data between Network Governor Balance Management and a carrier's Balance Management may be via batch file transfer or may be message-based. Alternatively, the separation between Network Governor Balance Management and Balance Management for non-spending limits subscribers is virtual and in fact spending limits subscriber data is hosted by the same hardware as that for non-spending limits subscribers.

Event-related data such as call duration, date, time, calling and called number location, and subscriber-specific call rating information, received from the Event Manager (and optionally via Roaming Record Acceleration function, discussed below) or carrier's Mediation platform (also discussed below), is rated immediately by Balance Management. A database of subscriber-specific data associated with Balance Management is then updated using the rated event data. While this is referred to as “balance” management, each subscriber record may maintain in addition to a current account balance: an identification of various applicable charge rates; an identification of default air, long distance, home and international carriers; free minutes and rates to which they are applicable; reward type, balance and expiration date; payment history; account security information; Intelligent Peripheral (IP) Voice Response Unit (VRU) language; credit card number and expiration date; and dates of account creation, activation, and scheduled termination, among other values. The subscriber database may be supported by any suitable large-scale, persistent data memory system.

If a call request from a roaming spending limits subscriber subject to post-call supervision is received by the Event Manager, a Roaming Record Acceleration (RRA) function of the Event Manager accumulates and expedites delivery of call-related data to Network Governor Balance Management and to the carrier's Balance Management via Mediation or direct connection (not illustrated) once the call is terminated. The Event Manager can be hosted by a switch adjunct to a serving MSC and thus has access to the call-related parameters necessary for subsequent call rating and balance management without the need for modifying the serving carrier's switch, network, operating routines, or roaming agreements. Immediate accumulation of call-related data and near real-time delivery of this data by the RRA function to Balance Management and/or to the carrier's Balance Management for rating and balance adjustment is thus enabled.

In the prior art, roaming call data is forwarded to the home carrier via a Clearinghouse associated with the wireless network. Delivery of data via the Clearinghouse can take days and negatively impact the latency with which these calls are rated and accounted for.

To address this deficiency, the RRA functionality can provide unrated CDRs to Network Governor Balance Management and/or to the carrier's Balance Management via Mediation in frequent batch submissions. One embodiment employs File Transfer Protocol (FTP) submissions of post-call supervised CDRs from the RRA to Network Governor Balance Management and/or to the carrier's Balance Management (via Mediation) every fifteen minutes. There may be plural CDRs for a single, complex (e.g., multi-party) call scenario. Also, even if only one accelerated CDR is provided via the RRA function, the serving carrier and wireless network Clearinghouse will still eventually deliver the standard CDR. A CDR filtration process, discussed below, is thus required.

If the subscriber is subject to real-time call control, the respective Event Manager interacts with Balance Management to determine the time available for the call and, after the call, collects call-related data as part of its monitoring function. Event Manager is thus capable of delivering call data to Balance Management immediately upon the call ending.

In order to determine whether a subscriber is in fact roaming, Network Governor must be able to identify the physical location of the subscriber and have access to data identifying the subscriber's home market. One way to accomplish this is for Treatment Handler and Balance Management to have access to a database of System Identifiers (SIDs) which help identify whether the current subscriber service area qualifies as a market subject to high latency record delivery from the Clearinghouse (“roaming market”). If so, Network Governor is invoked. In general, Network Governor determines whether a subscriber is roaming by analyzing an indication of serving carrier equipment versus Network Governor-maintained data identifying home versus roam equipment. The specific identifier used is dependent upon the network infrastructure and interface protocol employed by Network Governor.

An important concept in this regard is that ratable artifacts pertaining to a call or other event are accumulated immediately by the Event Manager and are expedited to Balance Management, either in real-time or, using RRA, in near real-time, for immediate rating and balance adjustment. This is in contrast to the prior art which employs the serving MSC and serving mediation and billing platforms for accumulating and forwarding event-related data to the Clearinghouse for receipt at the home carrier billing system at a relatively low temporal rate, or which requires a modification to a serving carrier's MSC and IT infrastructure to enable the porting of call-related data to a third-party data collection and forwarding device.

Regardless of whether roaming CDRs are received in real-time or near real-time, Balance Management must be capable of synchronizing and filtering CDRs received subsequently via the Clearinghouse process. Additionally, when Network Governor changes a subscriber's provisioning from near real-time supervision to real-time call control, certain CDRs generated when the subscriber was subject to near real-time supervision must still be rated and used for balance management. Thus, CDR filtration cannot be premised solely on the current treatment profile for the subscriber.

In one instance, the carrier's IT platform is configured to take no action with respect to internal rating and balance management or with respect to forwarding the CDR to Network Governor when a CDR is received from the Clearinghouse process for a spending limits subscriber. Because Network Governor provides alternative pathways for CDR generation and distribution, Clearinghouse data is not required for balance management. Optionally, Clearinghouse data may be stored in association with Network Governor or the carrier's legacy IT platform for reconciliation and data checking/auditing purposes.

In some embodiments, the Event Manager is also responsible for delivering call-related details to Balance Management for home area calls. In other embodiments, Event Manager is not used for home area subscribers having a favorable account status. In the latter case, call data is generated by a serving switch and forwarded to Balance Management via the carrier's Mediation platform. In either case, if a subscriber's account record indicates a satisfactory balance with respect to one or more spending limit thresholds, as determined by the Treatment Handler (discussed below), call data is measured, assembled upon call completion, and forwarded to Balance Management for rating and subscriber balance management. If the subscriber account has previously crossed one or more spending limits threshold(s), as determined by the Treatment Handler, the subscriber's activity is subject to real-time call control, in addition to CDR accumulation upon call termination and real-time rating and balance management. Real-time call control typically includes pre-call authorization and establishment of a maximum call duration limit followed by call timing and limit comparison. The use of more expensive resources implementing pre-call call processing and real-time monitoring is thus reserved for those subscribers with a sub-optimal account status.

A carrier may not want every type of event to be rated and applied against a subscriber's account. Network Governor is capable of filtering out events based upon a configurable set of filters. Each carrier has the ability to configure the filters according to its own preferences and requirements. Filters can be defined according to call disposition (e.g., call attempt, busy, ring/no answer, and runaway calls), call duration, and call disposition and duration combined.

Network Governor provides automated production and periodic delivery of summary data reports for billing purposes. Data in such reports includes the number of billable events and the number of enabled subscribers for the applicable period.

Prior art payment solutions have suffered from the prevalence of batch processing and relatively high latency in applying a payment to the subscriber account. Though a subscriber may submit authorization to charge a payment to a credit card, it may take several hours for the payment to be reflected in the subscriber's account. Each time the subscriber calls to see if the payment has been credited, the subscriber's calls may be routed to a Customer Service Representative (CSR), thus increasing carrier expense.

To address this inefficiency, Network Governor provides a payment and account interface and self-care module referred to as Payment Services. Network Governor in general, and the Balance Management subsystem in particular, is notified in real-time of a received payment, enabling rapid adjustment of the subscriber's account balance, thereby avoiding the expense of CSR intervention and the subscriber dissatisfaction resulting from delays in crediting payments. Even though the subscriber may be temporarily subject to real-time call control, the recently received and credited payment will satisfy pre-call authorization and a subsequent call will be allowed. Subscriber access to Payment Services is via a variety of Internet-based self-care portals (e.g., web-based, WAP, XML), IVR, CSR, etc. Payment Services can also be integrated with a carrier's legacy payment mechanisms such as Point of Sale (POS) terminals through the aforementioned interfaces in order to provide a wide payment footprint to subscribers.

Balance Management is preferably configured to notify the Treatment Handler following subscriber account-modifying activity. Such notification can be in real-time or near real-time. Real-time resources will be used more efficiently if Treatment Handler Smart Supervision causes the adjustment of subscriber treatment profiles shortly after payments are credited.

The logic with which Network Governor decides how to process a spending limits event is embodied functionally in the Treatment Handler. Each time an event involving a post-call supervised spending limits subscriber is completed, account data pertaining to that subscriber is provided to the Treatment Handler by Balance Management. This data is analyzed with respect to one or more predefined treatment thresholds and Business Rules maintained in association with the Treatment Handler in determining whether to invoke messaging and if so what type.

Should the Treatment Handler determine that the subscriber's account status is deficient or marginal with respect to one or more treatment thresholds, the Treatment Handler can invoke the Messaging Agent. Other bases for Messaging Agent use are possible. The Messaging Agent functional block receives account-related data and an identification of an appropriate message to be delivered to the subscriber from the Treatment Handler. The Event Manager is then responsible for configuring the call such that the subscriber is connected to the Messaging Agent to receive the assembled message. For instance, one such message can be via Voice Response Unit (VRU) which informs the subscriber of the current account balance and the need for payment due to an overdue balance, insufficient credit balance for Monthly Recurring Cost (MRC), or proximity to a spending limit. Another message can indicate to the subscriber that service will not be available until additional payment is provided. The latter scenario may include options which enable the subscriber to connect to Payment Services for immediate payment or to a CSR for other account-related assistance. Again, the Event Manager enables such connectivity.

Text messaging such as SMS can also be used. Depending upon the complexity of the Network Governor embodiment, messaging can be caused to occur on a periodic basis, such as in batch for all applicable subscribers at 9:00 a.m. (based on the subscriber's home time zone), or in real-time. Batch versus real-time messaging can also be premised on the nature of the message to be delivered and can be configured by the carrier. Text messages are not coordinated through the Event Manager.

Treatment Handler also provides Smart Supervision functionality. This functionality is capable of determining, on the basis of the subscriber account data, if the subscriber is still qualified for post-call supervision or, if certain thresholds have been crossed, whether real-time call control is appropriate. This decision requires access to the subscriber account database maintained in conjunction with Balance Management in order to consider applicable rate plan, month-to-date minutes for spending limited plans, credit class, account balance, and days past due, among other characteristics.

If Smart Supervision determines that event treatment for a subscriber should be changed from post-call supervision to real-time call control, the necessary network provisioning adjustments are performed. The specifics of Network Provisioning depend upon the network type. For example and as previously described, for an ANSI-41 implementation, Network Provisioning provisions subscribers with a particular class of service that results in calls being routed to a specific instance of Event Manager. For GSM implementations, a handset-resident resource such as a SIM can host a call management application provided to direct pre-call authorization requests for mobile originations or terminations to a different instance of Event Manager designed to interact with handset-based applications.

Once invoked, pre-call processing of real-time call control causes each call request pertaining to the affected subscriber to be forwarded to Balance Management to enable the calculation of a maximum allowable call duration value and to the Treatment Handler to determine if service is to be denied due to deficient account characteristics. The maximum duration value is then provided to the Event Manager which times the call and ensures it does not exceed this limit. Should the call in fact meet or exceed this limit, the Event Manager notifies the Treatment Handler for appropriate action, which may include reconfiguration of the call for the delivery of voice or text messages regarding low or exhausted balance, the interruption of the event, and the identification of account renewal options.

Once real-time call control has been defined for a subscriber, the Treatment Handler does not reevaluate the subscriber for alternative processing unless a payment is received and Balance Management alerts Treatment Handler to this fact. If the payment is enough to raise one or more subscriber account characteristics above respective treatment thresholds, the Treatment Handler instructs Network Provisioning to reflect this change such that subsequent subscriber activity receives post-call supervision.

Call flow for spending limits plans depends upon several factors including whether the subscriber is calling or is called and whether the subscriber is roaming or not. Also significant for determining call flow is the status of the subscriber's account relative to carrier-defined account-related thresholds. These thresholds can include maximum usage per billing cycle for various classes of service and minimum cash or credit balances.

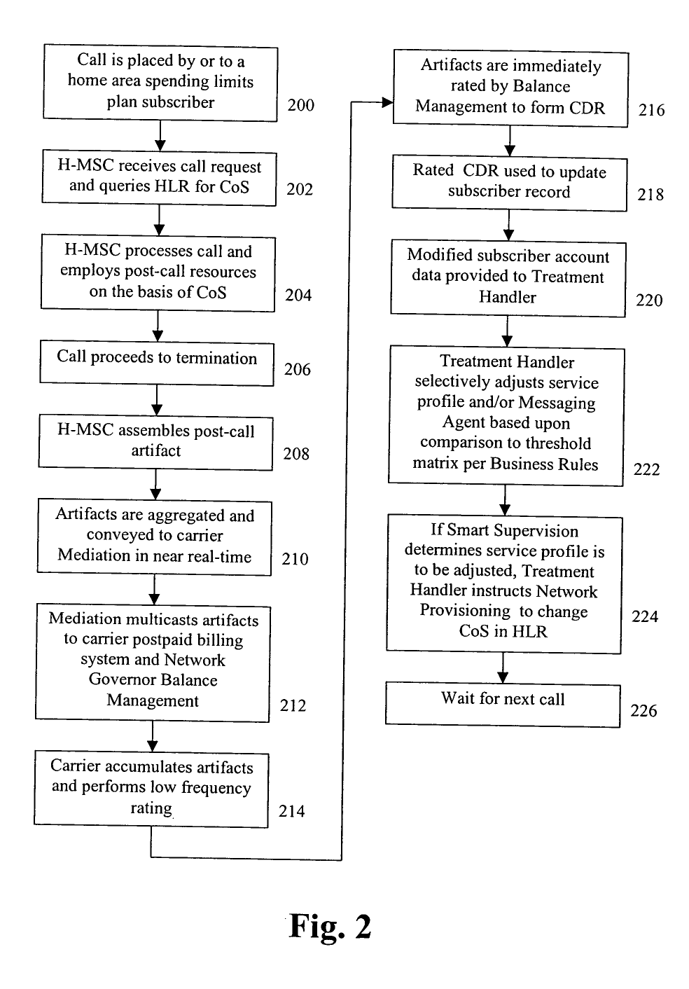

With reference to FIG. 2, a call flow for a spending limits subscriber calling or being called 200 in a home service area is illustrated. In this case, the subscriber account status, as previously analyzed by the Treatment Handler, is within an acceptable range. While this and subsequent call scenarios are described in the context of an ANSI-41 network, other networks are supported.

The call request is received by the home service area Mobile Switching Center (H-MSC) 202. In an ANSI-41 embodiment, the H-MSC references a Home Location Register (HLR) in order to determine the Class of Service (CoS) as an indication of how to handle the call request. The HLR data for this subscriber dictates to the H-MSC how to process the call request 204. In this case, the CoS indicates that real-time call control is not necessary.

Once the call is completed 206, the H-MSC (or handset-based application in other embodiments) assembles data characteristic of the call, which can be referred to as a post-call artifact 208. In other handset-based application embodiments, the application, in conjunction with other network elements, assembles call characterizing data. The artifact can also be referred to as an unrated Call Detail Record (CDR). It contains sufficient information such that Balance Management can rate the call in conjunction with the rating information in the subscriber's account.

Call detail artifacts are assembled by the H-MSC and are requested by the carrier system's Mediation platform in frequent batch requests 210. This may also be referred to as near real-time. Mediation multicasts artifacts both to other portions of the carrier's billing system and to the Network Governor Balance Manager 212.

The carrier Balance Management and Billing subsystem accumulates unfiltered artifacts and rates them in a standard post-paid batch procedure, which may occur at intervals such as once per day, per week, or per month 214. On the other hand, artifacts sent to Network Governor Balance Management are rated upon receipt and used for immediate balance adjustment. If Mediation is configured to send artifacts to the Network Governor, typically at intervals on the order of fifteen minutes, the artifacts are forwarded to Balance Management for immediate rating to form a CDR 216. The CDR is then used to immediately update the respective subscriber's account in the subscriber database associated with Balance Management 218.

Once the subscriber account has been updated for a post-call supervised subscriber, Balance Management provides Treatment Handler with account-related characteristics 220. Such characteristics can include cycle-to-date usage in currency or minutes for each of various call types (e.g. local, roaming, day, evening, night, weekend, etc.), credits available, reserve account status, and current treatment classification, among other metrics. In turn, Treatment Handler compares the account status with a matrix of thresholds 222, each of which when crossed dictate some change in subscriber treatment. For instance, if a threshold pertaining to the subscriber's reserve account balance is crossed, Treatment Handler will take the action specified for that threshold. In one instance, the Smart Supervision function of the Treatment Handler causes the subscriber treatment profile to change from post-call supervision to real-time call control 224, as described above.

Another type of action that Treatment Handler can take is to instruct the Event Manager to connect the subscriber prior to the next call initiation to the Messaging Agent for delivery of a message alerting the subscriber to the account status.

If none of the thresholds in the threshold matrix of the Treatment Handler are reached, the system simply waits for the next call placed by or to the subscriber 226.

Assume in the prior discussion that Smart Supervision had changed the treatment profile for a subscriber on the basis of comparisons between subscriber-specific account characteristics and the threshold matrix accessible by the Treatment Handler 222. Once again, Smart Supervision instructs the Network Provisioning function to alter the HLR entry, mobile handset-based application, or other subscriber-specific profile data such that future calls to or from that subscriber receive pre-call processing 224.

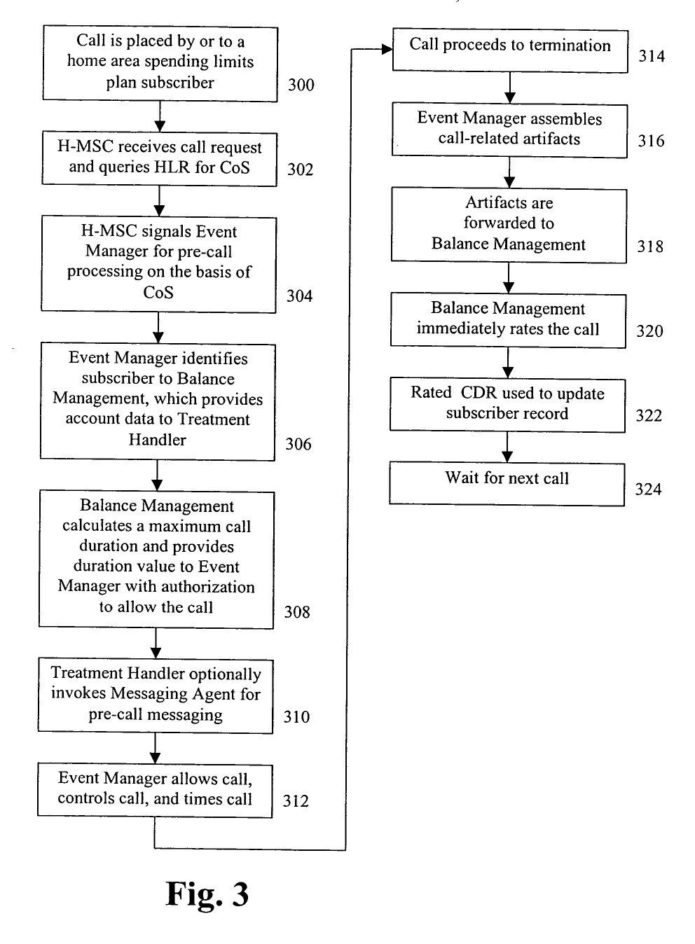

With reference to FIG. 3, a call to or from this home area subscriber 300, subsequent to modification of treatment handling instructions, is considered.

The H-MSC receives a call request and exchanges signaling with the Event Manager in order to determine how the call is to proceed 302. Another method (not illustrated), as described above, bypasses logic in the H-MSC and enables logic resident in the mobile handset to make this determination and signal directly to the Event Manager 300, 302. The signaling can take many forms: Integrated Services User Part (ISUP) protocol for a pre-Intelligent Network (pre-IN) implementation; Wireless Intelligent Network (WIN) protocol or Customized Applications for Mobile networks Enhanced Logic (CAMEL) protocol for an IN-based implementation; or short text messaging control messages for a SIM-based implementation.

The subscriber-specific data dictates that the call should be connected to the Event Manager for pre-call processing 304 in this example. The Event Manager, in turn, identifies the subscriber to the Balance Management subsystem, which then forwards subscriber account-related information to the Treatment Handler 306.

Balance Management calculates a maximum allowable call duration on the basis of the account-specific data and provides this maximum value to the Event Manager with authorization to allow the call 308. Under certain circumstances, it may be desirable for the subscriber to receive messages regarding the state of the respective account. If appropriate, the Treatment Handler can invoke the Messaging Agent to deliver a message as defined by the Treatment Handler 310.

In response to input from the Treatment Handler, the Event Manager allows the pending call and begins timing 312. For purposes of the present discussion, assume that the call terminates before the maximum time duration value has been reached 314. The Event Manager assembles call-related artifacts 316 and forwards those to the Balance Management subsystem 318. Upon receipt, the Balance Management subsystem rates the call on the basis of the artifacts 320. The rated CDR is then used by Balance Management to update the respective subscriber's account 322.

The system then waits for the next call 324.

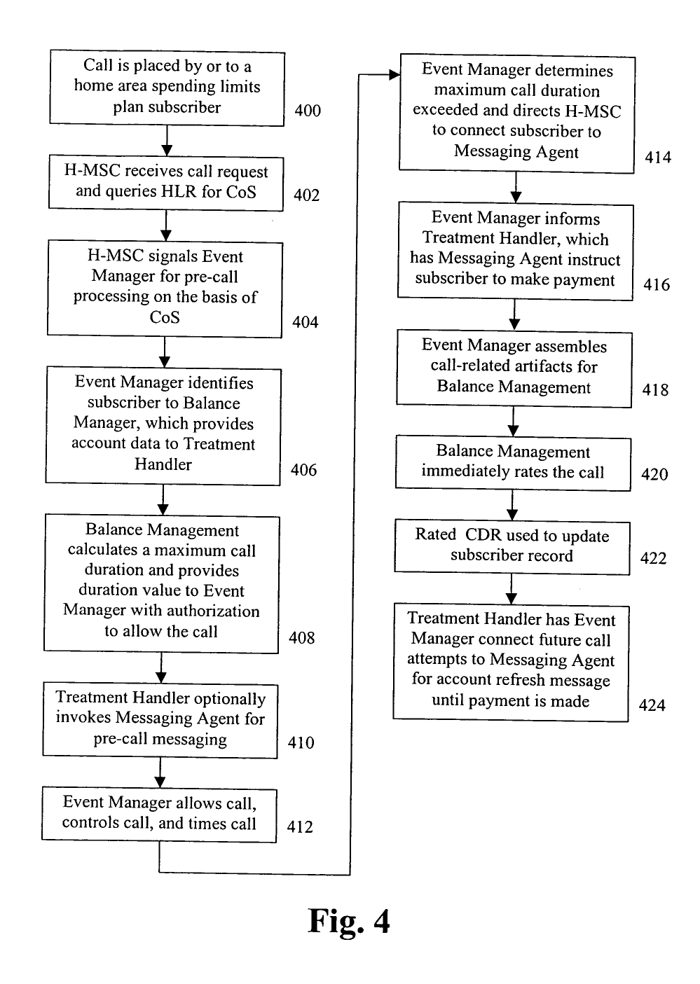

With reference to FIG. 4, call initiation 400, H-MSC retrieval of the subscriber treatment information from the HLR 402, and Event Manager, Balance Management, and Treatment Handler pre-call processing 404, 406, 408, 410, 412 are essentially the same as with respect to the call scenario depicted in FIG. 3. Unlike FIG. 3, however, the Event Manager now determines that the call duration has exceeded the maximum call duration value established by Balance Management. In this circumstance, the Event Manager directs the H-MSC to reconfigure the call in order to connect the subscriber to the Messaging Agent 414. Meanwhile, the Event Manager informs the Treatment Handler of the circumstance, and in turn the Treatment Handler instructs the Messaging Agent to provide a message to the subscriber indicating account balance deficiency or depletion and instructing the subscriber to make a payment to the account 416. The Messaging Agent can have the Event Manager reconfigure the call to connect the subscriber to Payment Services. If the subscriber is unable or unwilling to submit a payment, call tear-down may be initiated by the Event Manager (not illustrated).

At the same time, the Event Manager assembles call-related artifacts for the just-interrupted call and provides them to Balance Management 418, which rates the call on the basis of the artifacts 420, then updates the subscriber record accordingly 422. Because the Treatment Handler does not mandate a change in pre-call versus post-call treatment until after a payment has been received, future call requests will continue to be given pre-call processing, during which the Treatment Handler will require the subscriber to be connected to the Messaging Agent for receipt of a message indicating the existence of an account-related deficiency 424.

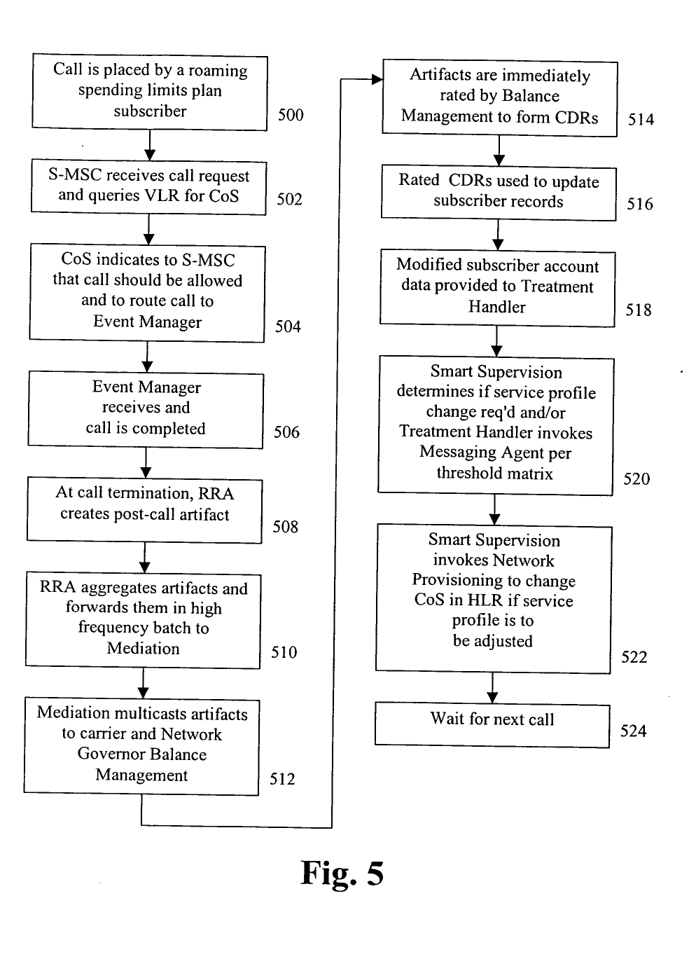

The call accounting process flow for a roaming subscriber is illustrated in FIG. 5. First, a call is placed by a roaming spending limits subscriber 500. A Serving MSC (S-MSC) receives the call request and forwards the request to the Network Governor Event Manager based upon the subscriber's profile information. Where this information is found depends upon the network implementation. For a GSM network, a handset-resident application provides the necessary profile information. For networks such as pre-IN, CAMEL, and Wireless Intelligent Network (WIN), the profile data can be found in association with a Home Location Register. Regardless, the profile information provides an indication to the serving carrier's resources as to how the call should be processed 502.

In most network embodiments, roaming call terminations can be handled similarly to roaming call originations. An exception to this is in an ANSI-41 environment that is not WIN-enabled. To handle roaming call terminations in this specific instance, Network Governor needs to acquire call origination information from the records that are generated in the home carrier MSC. As known in the industry, roaming call terminations generate a record in both the S-MSC and the H-MSC. This call detail record can be retrieved with a latency and according to a method similar to home calls, and can be delivered to Balance Management through the methods described herein (i.e., RRA). Nonetheless, even if an inbound roaming call is rated as a home call, it can still be processed by Network Governor as previously described with respect to FIGS. 2 through 4.

In the scenario illustrated in FIG. 5, it is assumed that the subscriber has an acceptable account status. Thus, the S-MSC receives an indication that the call should be allowed and to route it to a Network Governor Event Manager running as an adjunct switch (i.e. Hotline TIN) 504. In an environment in which the subscriber's phone has a handset-resident call control application, the application (in conjunction with other network elements) acts as the Event Manager and will measure and report the event without requiring re-routing as other technologies do.

The Event Manager receives the call and initiates call completion 506. Once the call is terminated, the Event Manager RRA functionality creates the post-call artifact, also referred to as an unrated CDR, using data accumulated during and characteristic of the call 508. The RRA function aggregates artifacts and periodically forwards them in batches to a carrier billing system, and in particular to a functional element such as Mediation 510. The rate of RRA batch submission of artifacts is relatively high, and in one instance is every fifteen minutes. Mediation then multicasts artifacts to the carrier postpaid billing system and to Network Governor Balance Management 512. As noted, in an alternative embodiment, RRA provides artifacts directly to the Balance Manager.

Once received, Balance Management rates artifacts to form CDRs 514, then manages subscriber account balances on the basis of the rated CDRs 516. Once modified, selected data from the subscriber's account is provided to the Treatment Handler 518. Smart Supervision can invoke real-time call control if certain treatment thresholds have been crossed. Also, Treatment Handler can invoke the Messaging Agent on the basis of a comparison between the subscriber's account data and the threshold matrix 520. As in the case of local calls, Smart Supervision invokes real-time call control for future calls by instructing Network Provisioning to change the subscriber data in the HLR (in a pre-IN ANSI-41 embodiment) 522. The system then waits for the next call to or from this subscriber 524.

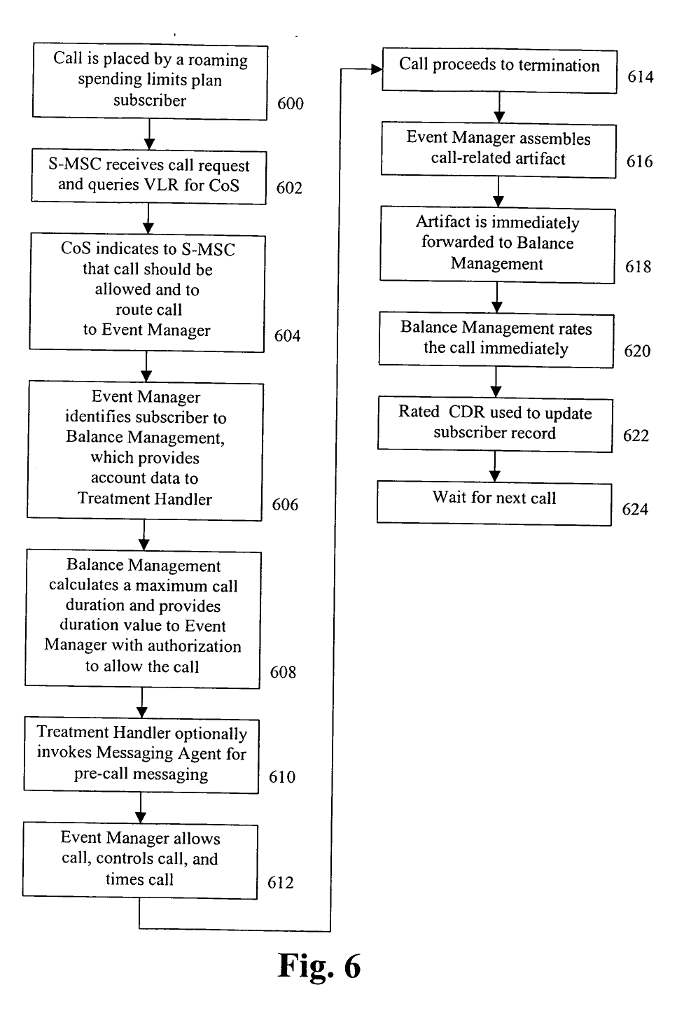

In FIG. 6, call flow for a calling, roaming subscriber whose account status has already warranted real-time call control is illustrated. Once a call is placed by the subscriber 600, the S-MSC in the ANSI-41 embodiment receives a call request and queries the VLR in order to access the treatment instructions contained within the HLR 602. In this case, the call is allowed but in the Pre-IN embodiment is routed to the Event Manager 604. With other network technologies, only signaling data is exchanged with the Event Manager. The Event Manager can be hosted in a number of locations such as the home carrier's network or in a third party network.

At the Event Manager, the subscriber is identified to Balance Management, which provides account-related data to the Treatment Handler 606. Balance Management calculates a maximum allowable call duration on the basis of account data and returns this value to the Event Manager 608. If appropriate, Treatment Handler may instruct the Event Manager to connect the call to the Messaging Agent and instruct the Messaging Agent to voice a payment or other message to the subscriber 610. The Event Manager then allows the call, controls the call, and times the call 612.

In this illustrated scenario, the call terminates before the maximum call duration value is reached 614. The Event Manager assembles a call-related artifact 616 and forwards it to Balance Management 618 for rating 620. The rated CDR is promptly used to update the subscriber account by Balance Management 622. The system is then ready to process the next call 624.

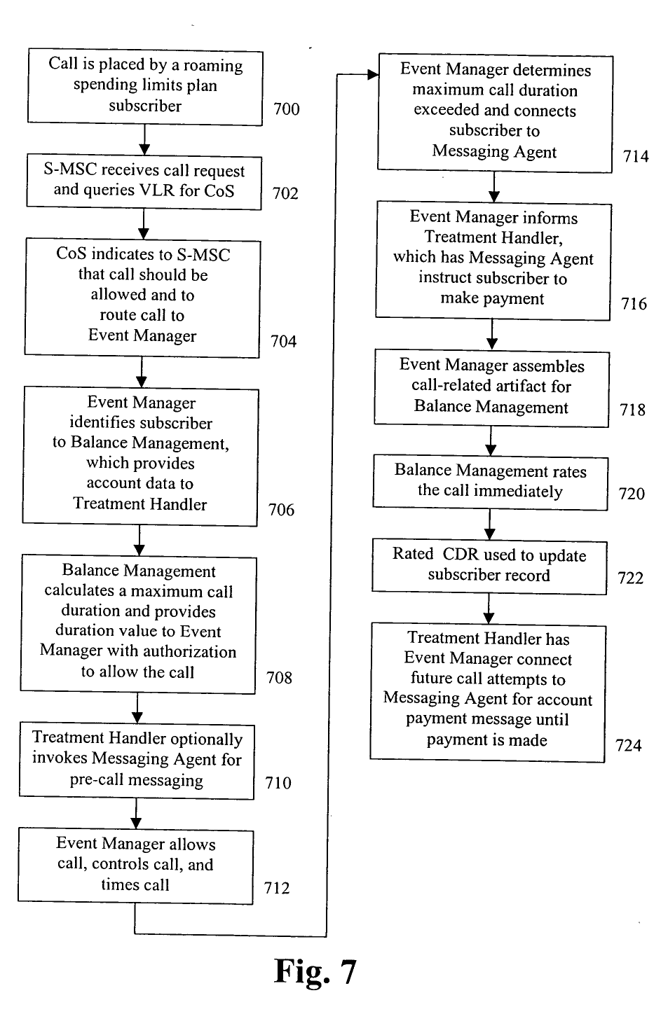

In FIG. 7, a call is placed by a roaming subscriber previously designated as subject to real-time call control 700. The S-MSC in the ANSI-41 embodiment receives a call request and queries the VLR to access the treatment instructions contained within the HLR 702. The CoS indicates to the S-MSC that the call should be allowed and to connect the call to the Event Manager 704. As in the previous example, the Event Manager identifies the subscriber to Balance Management, which provides account-specific data to the Treatment Handler 706. Balance Management calculates a maximum call duration value from this data and provides the value to the Event Manager with authorization to allow the call 708. The Treatment Handler also has the option of having the call connected to the Messaging Agent for pre-call message delivery 710.

The Event Manager allows the call, controls the call, and times the call in real-time 712. In this case, assume that the call has exceeded the maximum duration value determined by the Balance Management 714. The Event Manager reconfigures the call to connect the subscriber to the Messaging Agent 714, and indicates to the Treatment Handler that the maximum time value has been exceeded, causing the Treatment Handler to instruct the Messaging Agent to voice a message requesting an account payment 716, for example. Call tear-down can then be optionally initiated by the Event Manager (not illustrated).

The Event Manager assembles call-related artifact and provides it to Balance Management 718 for rating 720. The rated CDR is then used by Balance Management to update the subscriber account data 722. All future call attempts by or to the subscriber are routed to the Treatment Handler which has access to the subscriber's account data and determines that there is insufficient credit to authorize the requested call. The Messaging Agent is invoked at each call attempt until Balance Management determines adequate resources exist to allow the call or until Balance Management indicates to Treatment Handler that an account modification has occurred and Treatment Handler determines the account qualifies for a change in service class or treatment 724. Once this occurs, Treatment Handler instructs Network Provisioning to change the subscriber profile to post-call supervision.

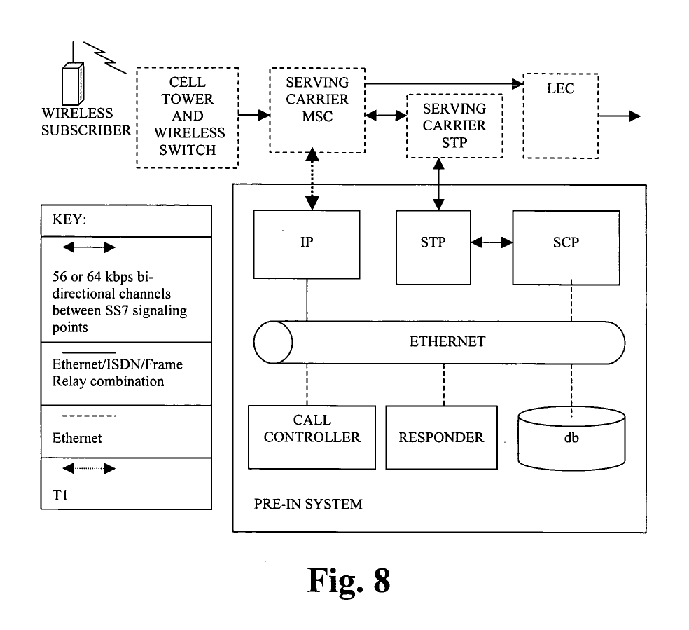

The functional blocks illustrated in the standalone Network Governor configuration shown in FIG. 1 can be implemented by a number of physical systems. One such system, shown in FIG. 8, is referred to as a Pre-IN System. The call processing architecture of the Pre-IN System takes advantage of out-of-band signaling to perform real-time call control. Optional pre- and post-call voice messages can be delivered by temporarily connecting the call to a regionally located Intelligent Peripheral (IP).

The principal components of the Pre-IN System include: a subscriber database (db) of subscriber account information; a Responder serving as an interface to the subscriber database; an Intelligent Peripheral (IP) for voicing messages including messages regarding account balance to a subscriber and optionally for collecting subscriber input through dialed digit collection; a Call Controller for directing call-processing and call-control; and an SS7 Service Control Point (SCP) hosting an Integrated Services Digital Network User Part (ISUP) Application and an SS7 stack for interfacing with the carrier equipment.

The cell tower, wireless switch, MSC and associated Signal Transfer Point (STP) nodes are all part of the serving carrier's service realm. A Local Exchange Carrier (LEC) is a wireline carrier serving a certain geographic region and in the illustrated example serves to interface the wireless calls handled by the serving carrier to a wireline network.

The subscriber database is indexed by a subscriber identifier such as a Mobile Identification Number (MIN). Each subscriber record comprises a number of parameters characterizing the respective subscriber's account. Access to the subscriber database is provided by the Responder. The Responder may be provided as a specially-programmed general purpose computer or may be implemented as a customized data accessing and processing device. In addition to interfacing with the subscriber database for data retrieval and updating, the Responder is responsible for call rating based upon call-related data and subscriber record data and optionally for generating a message script information file for use by the Intelligent Peripheral VRU. Communication between the Responder and the subscriber database is preferably via an Ethernet connection.

The Call Controller is in communication with the Responder via a data network such as Ethernet. The Call Controller provides call-processing functions based upon call-related data provided by the ISUP Application and account-related information for the respective subscriber provided by the Responder. The Call Controller also provides flow control for message scripts to the Intelligent Peripheral and times the call once the call is connected from the caller to the call-recipient. The Call Controller also stores call context (e.g., rate plan, rate amounts, rate period start and end) for the Responder while a call is set up and in progress.

The SS7 SCP, running the ISUP Application, acts as an interface between a Mobile Services Switching Center (MSC) of a serving carrier and the subscriber data accessed by the Responder. The serving carrier may be the subscriber's home wireless service provider, or may be a third party service provider. Signaling information in SS7 format is conveyed through a separate SS7 data network in the industry-standard ISUP format. More information about each call can be provided as compared to in-band signaling. The ISUP Application keeps call-state information (e.g., an indication messages have been received and sent including relevant parameters such as ANI, DNIS, etc.), implements call-flow capabilities, accesses messaging resources, and stores Call Controller context. In an alternative embodiment, the ISUP Application also stores Responder context. Intermediate the serving carrier's MSC and the SS7 SCP are respective industry-standard STP nodes.

The Intelligent Peripheral includes a Voice Response Unit (VRU) which is provided with script message information by the Call Controller via TCP/IP socket connection with the ISUP Application. The Intelligent Peripheral is selectively in communication with the serving carrier via a T1 connection established at the beginning and optionally at the end of each subscriber-originated call. The Intelligent Peripheral is principally concerned with playing voice messages based upon the script message information and collecting digits transmitted to it. TCP/IP is employed as the protocol between the Intelligent Peripheral, ISUP Application, and Responder. The Intelligent Peripheral is preferably located proximate one or more serving carrier locations (regionally or co-located) in order to minimize the distance between the Intelligent Peripheral and MSC, whereas the SC7 SSP, Call Controller, Responder, and subscriber database are typically provided at locations remote from the service providers.

The serving carrier must configure its MSC to provide loop-around trunk groups, as well as trunk groups that connect to the Intelligent Peripheral. In addition, the MSC must provide Temporary Local Directory Numbers (TLDNs) for connecting calls to the Intelligent Peripheral. A hotline TIN can be used to eliminate these requirements for off-net roaming.

As indicated above, the Network Governor system, functionally depicted in a standalone configuration in FIG. 1, can be implemented by the Pre-IN System of FIG. 8, as well as by other suitable hardware platforms. In the context of the Pre-IN System, the Event Manager functional subsystem of FIG. 1 is implemented by the front end of the Pre-IN call processing architecture, and specifically by the Pre-IN STP node, the SS7 SCP node running the ISUP application and hosting the ISUP stack, and the Call Controller. The STP node provides an addressable interface to the Wireless Network and the Call Controller executes the call-processing and call-control functions of the Event Manager. In the illustrated embodiment, the interface employs SS7 out-of-band signaling for exchanging call-control information with the wireless network. Other signaling standards can be employed.

Roaming record acceleration for roaming events associated with subscribers requiring post-call processing is also performed by the Call Controller. As described above, the Call Controller times events while they are in progress and maintains call state information, including an identification of a roaming event. Once such an event is complete, the event-characterizing data is forwarded to the Responder.

Network Governor Balance Management functions are performed by the Responder in conjunction with the subscriber database. The Responder is responsible for assembling the event-characterizing data into the Call Data Record (CDR) format appropriate for that carrier and for rating the event on the basis of the CDR.

Payment Services are implemented in the illustrated embodiment through the Intelligent Peripheral and the Responder. Because the Responder has direct access to the subscriber database, delays in posting payments or credits to a subscriber account are minimized.

The Treatment Handler functionality of Network Governor is also carried out by the Call Controller and Responder. Account-related thresholds are defined such that real-time call control and/or messaging may be invoked, depending upon the status of the respective account. If a pre-call and/or post-call message is to be conveyed to a subscriber, the Responder is the element that defines the appropriate message and directs the Intelligent Peripheral to voice the message once instructed by the ISUP Application. In that the Responder provides the call rating capabilities necessary for Balance Management, it is also responsible for implementing the Smart Supervision function, i.e., it determines when it is appropriate to switch between real-time and near real-time call control and vice versa. The Balance Management function of determining a maximum allowable call duration is carried out by the Responder and this value is conveyed to the Call Controller for use during real-time call monitoring.

The Network Governor embodiment of FIG. 1 avoids complexity in that minimal changes are required to a carrier's IT infrastructure. Through appropriate network provisioning, spending limits subscriber calls are handled exclusively by Network Governor. Certain redundancies may result, however, such as duplicate balance management and payment services platforms.

Instead of discrete instances of Balance Management for each of the carrier's IT platform and for Network Governor, one Balance Management system can be shared by both. Call handling for spending limits subscribers continues to be the responsibility of the Network Governor Event Manager as a result of appropriate network provisioning. If Balance Management is hosted by the carrier's IT platform, a marginal amount of latency in forwarding unrated CDRs in high-frequency batch submissions is introduced. Of course, such CDR transmissions can also be provided via message-based resources, a more expensive solution but one which minimizes latency.

A simpler version of Network Governor, as compared to the embodiments previously described, includes the Event Manager, the RRA function, a simplified version of Treatment Handler which only handles messaging conditions, and the Messaging Agent. Such an embodiment is particularly appropriate for carriers who have an acceptable level of latency for home area calls, but who wish to have better control over roaming subscriber usage. As there is no Smart Supervision functionality in this particular instance of Treatment Handler, there is no differentiation between real-time call control subscribers versus post-call supervised subscribers. Thus, all roaming calls are subject to RRA processing. This necessitates the use of some form of synchronization and filtering to prevent duplicate processing of CDRs pertaining to the same event, as described above.

What is claimed is:

1. A system enabling accelerated accounting of an event initiated in a wireless telecommunications system by a roaming subscriber to a telecommunications service plan offered by a home service provider, comprising:
a serving switch associated with a serving carrier for receiving a request to initiate the event from a subscriber device;
an event manager associated with the home service provider for receiving the call request from the serving switch, for fulfilling the event initiation request, for accumulating data characterizing the event once initiated, and for transmitting the event characterizing data after the event has concluded; and
a subscriber database comprised of subscriber records for telecommunications service plan subscribers of the home service provider; and
a balance manager functionally associated with the subscriber database for receiving the transmitted event characterizing data from the event manager and for modifying the respective subscriber record in the subscriber database on the basis of the event characterizing data.
